(19) United States
(12) Patent Application Publication
(10) Pub. No.: US 2014/0350957 A1
(43) Pub. Date: Nov. 27, 2014

(54) METHOD AND SYSTEM FOR REDUCING EARLY READMISSION

(71) Applicant: KONINKLIJKE PHILIPS N.V., EINDHOVEN (NL)

(72) Inventors: Rony Calo, Utrecht (NL); Gijs Geleijnse, Geldrop (NL); Aleksandra Tesanovic, Eindhoven (NL)

(21) Appl. No.: 14/368,368

(22) PCT Filed: Dec. 21, 2012
(86) PCT No.: PCT/IB2012/057599

§ 371 Date: Jun. 24, 2014

Related U.S. Application Data
(60) Provisional application No. 61/580,520, filed on Dec. 27, 2011.

(51) Int. Cl. G06F 19/00

(52) U.S. Cl. CPC G06F 19/3431; G06F 19/322
USPC 705/2

(57) ABSTRACT

The exemplary embodiments are related to systems and methods for reducing early readmission according to an exemplary embodiment described herein. One embodiment relates to a method comprising receiving patient data for a patient; creating a personalized risk model for the patient based on the patient data, the personalized risk model including an overall risk level based on a plurality of risk factors; selecting one of the risk factors; administering treatment relating to the selected risk factor; updating the personalized risk model after administering treatment, the updating including determining an updated risk level; determining whether the updated risk level is above a threshold level; and repeating the selecting, administering, updating and determining steps if the risk level is above the threshold level.

Hospitalized heart failure (“HF”) patients typically have a high risk of early readmission. The readmission rate for HF patients may be as high as one in three within 30 days of discharge and one in two within a year. To reduce the chance of readmission, healthcare providers typically assess the patient's risk of readmission and plan their treatment accordingly.

A patient's risk of readmission may be assessed only once during the patient's hospital stay, either at admission or at discharge, and the patient is classified as a high, medium, or low risk of readmission. Assessment at admission may enable healthcare professionals treating the patient during hospitalization to address contributing medical risk factors with medicine and therapy during the patient's hospital stay. Conversely, assessment at discharge may give guidance to healthcare professionals treating the patient in the post-therapy outpatient setting. These approaches may be deficient because only medical risks may be addressed during hospitalization, while the opportunity to address psychosocial risks and further reduce the risk of readmissions is missed.

Exemplary embodiments of the present invention are related to systems and methods for reducing early readmission according to an exemplary embodiment described herein. One embodiment relates to a method comprising receiving patient data for a patient; creating a personalized risk model for the patient based on the patient data, the personalized risk model including an overall risk level based on a plurality of risk factors; selecting one of the risk factors; administering treatment relating to the selected risk factor; updating the personalized risk model after administering treatment, the updating including determining an updated risk level; determining whether the updated risk level is above a threshold level; and repeating the selecting, administering, updating and determining steps if the risk level is above the threshold level.

Another exemplary embodiment of the present invention relates to the system which comprises a memory storing a plurality of validated risk models; and a processor receiving patient data for a patient, creating a personalized risk model for the patient based on the patient data, the personalized risk model including an overall risk level based on a plurality of risk factors, selecting one of the risk factors for treatment; receiving a result of treatment relating to the selected risk factor, updating the personalized risk model based on the result of treatment, the updating including determining an updated risk level, determining whether the updated risk level is above a threshold level, and selecting a further one of the risk factors for treatment if the risk level is above the threshold level.

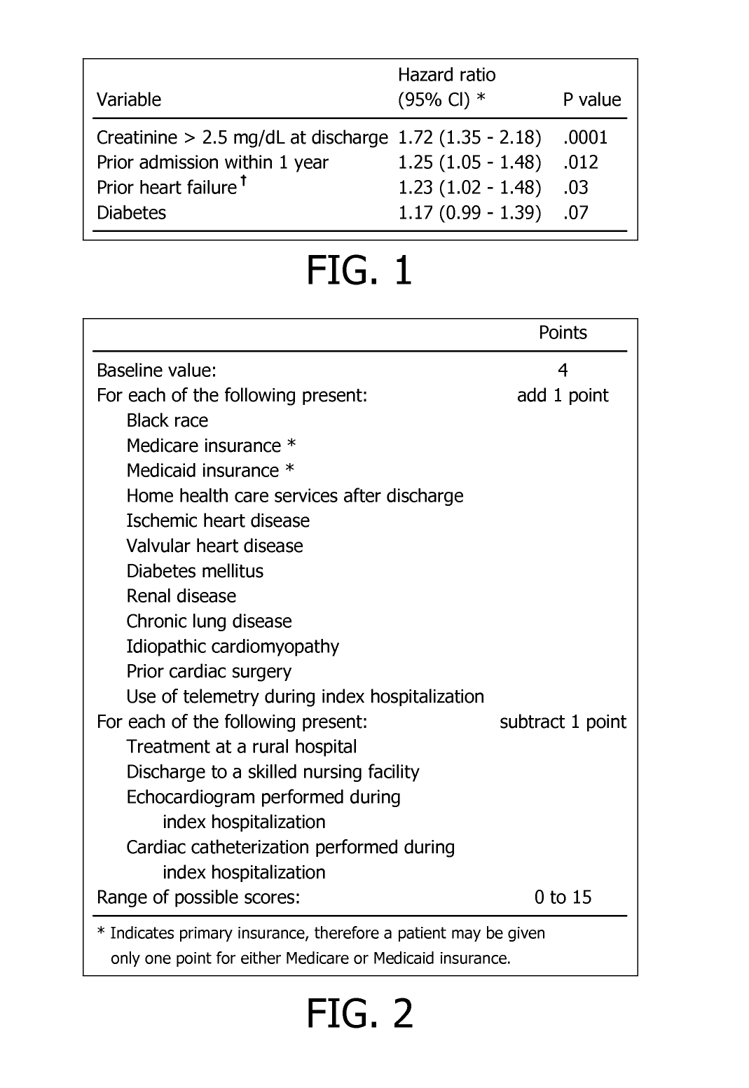

FIG. 1 shows a first exemplary risk model for use in assessing a patient's risks of readmission according to an exemplary embodiment.

FIG. 2 shows a second exemplary risk model for use in assessing a patient's risks of readmission according to an exemplary embodiment.

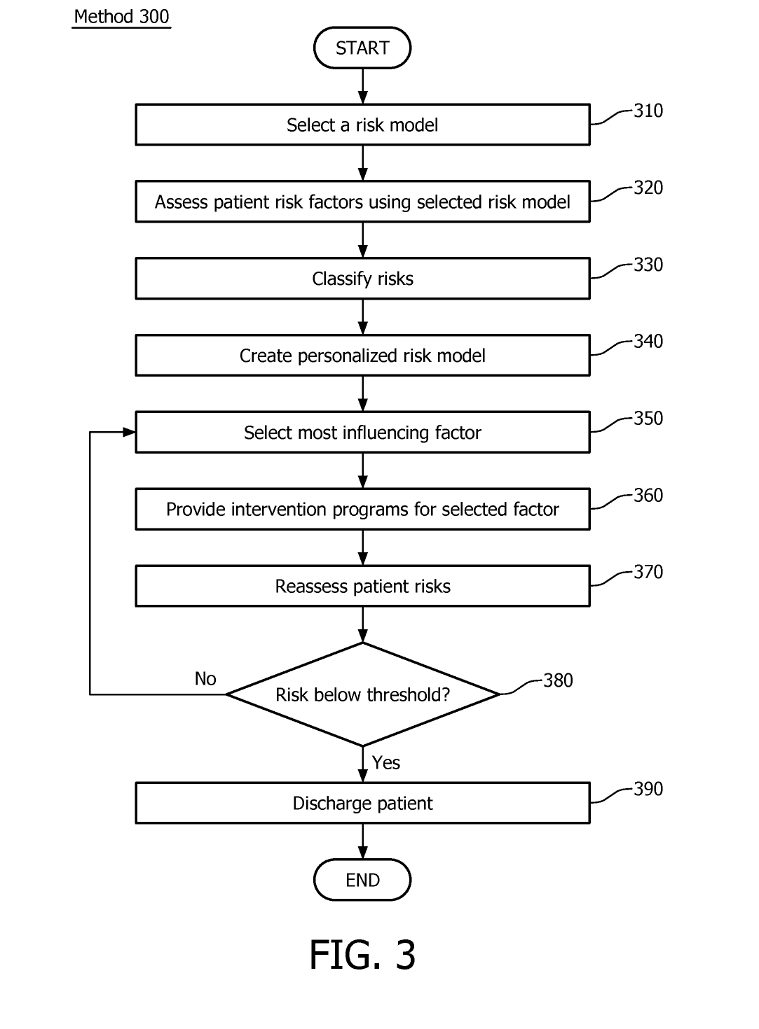

FIG. 3 shows an exemplary method for assessing and reducing a patient's risks of readmission according to an exemplary embodiment.

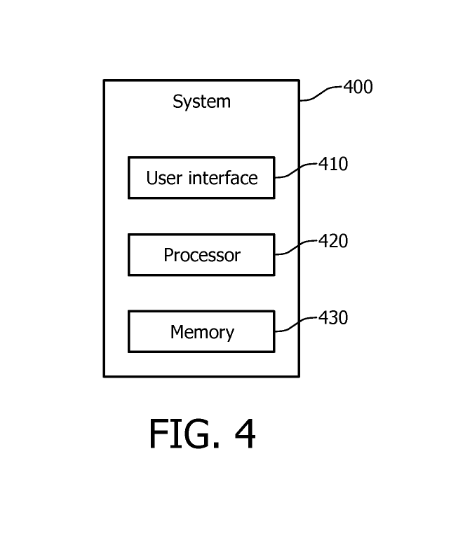

FIG. 4 shows an exemplary system for implementing a method such as the method of FIG. 3 for assessing and reducing a patient's risks of readmission according to an exemplary embodiment.

The exemplary embodiments of the present invention may be further understood with reference to the following description of exemplary embodiments and the related appended drawings, wherein like elements are provided with the same reference numerals. Specifically, the exemplary embodiments relate to methods and systems for assessing and reducing the risks of readmission for hospitalized heart failure patients. However, those of skill in the art will understand that while the exemplary embodiments make specific reference to heart failure (“HF”) patients, the principles described herein may also be applied to reduce the risk of readmission for patients having any other type of illness or injury. This may include, for example, patients suffering from diabetes, pneumonia, or any other condition that may put a patient at risk for readmission.

Patients who have been hospitalized for HF have a high rate of early readmission. One in three hospitalized HF patients is readmitted within 30 days after discharge, and roughly 50% are readmitted within a year. To combat this risk, each hospitalized HF patient has his or her individual risk assessed during hospitalization, in order that medical professionals may address specific risk factors relating to the patient. There are a variety of validated risk models that have been designed by medical professionals to assess the readmission risks for a particular patient. The models receive, as input, a number of patient-related risk factors/parameters, and output the probability of readmission. One risk model is the Krumholtz et al. (2000) model, which is shown in FIG. 1. Another risk model is the Philbin et al. (1999) model, which is shown in FIG. 2.

Those of skill in the art will understand that the two risk models discussed above are only exemplary, and that other alternative risk models may be used. Risk factors may be divided into medical risks (e.g., symptoms, medical history, co-morbidities, vital signs, treatment, etc.) and psychosocial risks (e.g., depression, financial status, existence of support structures, etc.). It is important to address a patient's medical risks during hospitalization in order to ensure that the patient is in stable condition before discharge. However, psychosocial risk factors may be more difficult to address, and furthermore may be influential to a patient's risk of readmission, as the presence of psychosocial risk factors may reduce the patient's chances of adherence to post-discharge self-management behaviors (e.g., restriction of sodium and alcohol intake, managing physical activity, monitoring signs and symptoms, smoking cessation, keeping follow-up appointments, etc.). Adherence to self-management behaviors may be crucial, because it has been proven that such adherence reduces the risk of readmission, and, thus, the presence of psychosocial risk factors increases the risk of readmission.

Psychosocial risk factors are divided into those that are modifiable (during the period of hospitalization) and those that are unmodifiable. Examples of modifiable risk factors are depression and low self-efficacy for complying with self-management behaviors. Such risks may be directly addressed and modified during hospitalization, such as through counseling. Examples of unmodifiable risk factors are household composition, income, type of insurance, and health literacy. These are risks that cannot be directly addressed during hospitalization.

Current models typically involve risk assessment in the hospital only once, either at admission or at discharge, such as using one of the risk models described above or using some other method of risk assessment. Based on such classification, the patient may then be classified as a high, medium, or low risk of readmission. Assessment at admission may reveal contributing medical risk factors that may be treated with medicine and therapy during the hospital stay. Conversely, assessment at discharge may provide guidance for medical professionals providing treatment in an outpatient setting after discharge. The value of this type of risk assessment is limited, as only medical risks can be addressed, while the opportunity to address psychosocial risks during the hospital stay, and thereby reduce readmissions, is missed.

The exemplary embodiments provide a reduction of readmission risks relating to psychosocial risk factors. FIG. 3 illustrates an exemplary method 300 for assessing and reducing the risks for a hospitalized HF patient. In step 310, a risk model is selected for the patient. The risk model may be selected from among a group of available models, which may include, but is not limited to, those described above. Selection may be performed manually, such as by the patient's physician or other medical professional, or may be automatically performed, such as using an algorithm. In another embodiment, the same model may be used for all patients, and no selection takes place.

In step 320, the risk model selected in step 310 is used to assess the risk factors applicable to the patient, and determine the patient's risk of readmission on the basis of those risks. This step may proceed substantially in the manner for applying a risk model that is known in the art. In step 330, each of the risk factors that were determined to be relevant to the patient is classified as either medical or psychosocial risk factors. At this point, medical risk factors are provided to the medical professionals treating the patient, in order that the patient may be treated with medicines and/or therapy using techniques that are known in the art. The medical risk factors are removed from consideration by the method 300, which, as discussed above, is focused on psychosocial risk factors.

In step 340, a personalized risk model is created for the patient based on the psychosocial risks determined in steps 320 and 330. This involves the classification of various psychosocial risk factors based on their effect on patient maintenance behaviors, and will be discussed in greater detail below.

Initially, it should be noted that each unmodifiable psychosocial risk factor may have several underlying ways in which it affects a patient's ability to comply with maintenance behaviors, and thereby affects the risk of readmission. For example, a patient who has the unmodifiable psychosocial risk “single” will remain single upon discharge. This may affect several maintenance behaviors. For example, this may lead to the patient not having transportation to and from appointments; this may be remedied by suggesting to the patient alternative means of transportation. Further, this may lead to the patient not having reminders from family members of proper healthy behavior; this may be remedied by suggesting strategies for memory enhancement to the patient. Additionally, the patient's “single” status may lead to difficulty in selecting and preparing appropriate meals; this may be remedied by providing the patient with cooking tips and lists of appropriate products. Moreover, this may lead to the patient having difficulty timing the intake of medication; this may be remedied by providing the patient with instructions on how to use solutions such as pill counters to time the intake properly.

It should also be noted that some psychosocial risk factors may be directly modifiable by medical professionals. For example, a patient suffering from negative affect may be treated with a cognitive behavioral intervention. A low level of self-efficacy can be addressed by skill building. A patient having negative beliefs about the ability to comply with self management behaviors can be treated by providing persuasive counter-arguments to those beliefs.

Additionally, each unmodifiable risk factor may be composed of underlying modifiable factors; a database may be used to store the modifiable factors relating to each unmodifiable factor. For example, an unmodifiable psychosocial risk factor of “single” for household composition may be decomposed into modifiable factors “lack of transportation to follow-up appointments”, “lack of medication reminders”, and “difficulty in selecting/preparing healthy meals”. The patient may then be provided with instruction relating to the appropriate modifiable factors.

Thus, in step 340, unmodifiable risk factors are analyzed to determine the relevant underlying modifiable factors, in order to inform treatment of the patient. The patient's electronic health record (“EHR”) is consulted to retrieve existing values for any factors relating to the patient. For example, for a risk model using “single” as a risk factor, the retrieved value may be “yes” or “no”; for a risk model using “household composition” as a risk factor, the retrieved value may be “lives alone”, “lives with partner”, lives with children”, etc. For risk factors for which no values are found, or for which no data fields are defined in the EHR, the patient is assessed; this may be done by evaluation by medical professionals, or by questionnaires given to the patient. When the data has been collected, a risk model (e.g., the risk model discussed above) is run on the factor values, resulting in an initial assessment of the patient's risk, and an overview of the psychosocial risk factors. Those of skill in the art will understand that these may be broken down into modifiable psychosocial risk factors and unmodifiable psychosocial risk factors as described above.

Next, the patient is presented with a set of questionnaires to assess the modifiable risk factors relating to the unmodifiable psychosocial risk factors. Typically, one questionnaire is administered for each unmodifiable psychosocial risk factor, and the questionnaires may be maintained in the same database that may store the modifiable risk factors relating to each unmodifiable risk factor. This results in a personalized decomposition into modifiable risk factors relevant to the patient. In one example, as described above, a patient may have a risk factor “single”. This may be decomposed into “difficulty managing transportation to appointments”, “difficulty adhering to a course of medication”, “difficulty preparing heart-healthy meals”, and “difficulty monitoring health status”, all of which those of skill in the art will understand are directly modifiable. This decomposition is assessed by measuring the applicability and relevance of all known underlying factors. For example, a given patient may have daily in-home nursing assistance, and therefore, may have health status monitored on a daily basis. For such a patient, “difficulty monitoring health status” may be inapplicable, and only the other three factors may be relevant.

Additionally, for each modifiable risk factor, the questionnaires result in a prediction score that assesses the expected success of an intervention for the factor for the patient. The prediction score may be assessed using a combination of questionnaires related to the ability and readiness for change of the patient. The above results combine to provide the personalized risk model for the patient. The personalized risk model includes all medical factors, all unmodifiable psychosocial risk factors, and all underlying modifiable factors. Each factor is associated with an importance score, which may be a parameter of the validated risk model, determined based on knowledge in the art (e.g., based on technical literature or clinical guidelines), manually by a medical professional, etc. The importance score is used to assess the relative contributions of the underlying risk factors to the risk factor in the original model. For example, continuing with the “single” example described above, the four underlying factors may be weighted as “difficulty managing transportation to appointments”: 4; “difficulty adhering to a course of medication”: 3; “difficulty preparing heart-healthy meals”: 2; and “difficulty monitoring health status”: 4. Because the factor “difficulty monitoring health status” is irrelevant to the patient, the score may be weighted as (4+3+2)/(4+3+2+4)=0.69 times the importance of the risk factor “single” in the validated risk model. If the patient subsequently has an intervention for the factor “difficulty managing transportation to appointments”, and the factor is therefore adjudged to be resolved, the score may then be weighted as (3+2)/(4+3+2+4)=0.38 times the importance of the risk factor in the validated risk model in subsequent evaluation of the patient's risks.

In step 350, a most influencing risk factor is selected from among the modifiable psychosocial risk factors and the unmodifiable psychosocial risk factors (as broken down into their constituent underlying factors). This is done by means of a score that combines both the contribution of the factor to the overall risk assessment, and the patient's ability to change the related self-management behavior. The factor that is selected is the one that has the highest combination of both impact and ability to change. In step 360, intervention programs relating to the selected risk factor are chosen and provided to the patient during hospitalization, in the manner that is known in the art.

In step 370, after the appropriate intervention programs have been administered to the patient, the patient's risks are reassessed by readministering the questionnaires and other processes described with reference to step 340; medical risk factors are again considered in this step as part of the overall evaluation of the patient's risk. In step 380, the patient's updated and, ideally, improved risk score is compared to a threshold value, which may be determined by medical professionals to represent a safe condition for discharge. If the updated risk score remains above the threshold value, the method returns to step 350, where a new most influencing risk factor is selected based on the updated risk profile, and the method continues again through steps 350 through 380. If the updated risk score is below the threshold value, the method continues to step 390, in which the patient is deemed to have a low enough risk of readmission to be discharged. After step 390, the method terminates.

The exemplary method 300 may be implemented in a variety of manners. In one example, the exemplary method 300 may be implemented by a computer through an exemplary system 400. The system 400 is illustrated schematically in FIG. 4. A user interface 410 is operable to receive various types of user input, such as a selection of a risk model, patient diagnostic data, questionnaire responses, etc. Those of skill in the art will understand that though the exemplary system 400 is shown to include a single user interface 410, other systems may use multiple user interfaces, such as providing one user interface for medical professionals and another for patients to enter questionnaire responses. The user interface 210 is also used as an output device, e.g., it may output questionnaires, results, etc.

The user interface 410 provides data to a processor 420 that may execute a program embodying the exemplary method 300. Data relating to this task may be stored in a memory 430. The memory 430 may be a hard drive, a solid state drive, distributed storage, etc., and may store data in any format appropriate for use as described above. In addition to the instructions necessary to perform the method 300, the memory 430 may store medical records relating to patients in the hospital housing the system 400. Alternately, patient records may be stored remotely, such as in a centralized system for storing such records.

The exemplary embodiments provide a mechanism by which psychosocial factors impacting the rate of readmission of HF patients may be treated concurrently with medical factors during hospitalization. Further, treatment of psychosocial factors is personalized to each individual patient, based on the patient's individual risk factors, the comparative weight of the factors, and the patient's ability to change the corresponding behaviors. Thus, patients are provided with treatment that is appropriate to their individual circumstances and have their risks of readmission reduced.

As discussed above, those of skill in the art will understand that while the exemplary embodiments have been described specifically with reference to patients who have been hospitalized for heart failure, the principles described herein may also be applied to reduce the risk of readmission for patients having any other type of illness or injury. This may include, for example, patients suffering from diabetes, pneumonia, or any other condition that may put a patient at risk for readmission.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

1. A method, comprising:
receiving patient data for a patient;
creating a personalized risk model for the patient based on the patient data, the personalized risk model including an overall risk level based on a plurality of risk factors;
selecting one of the risk factors;
administering treatment relating to the selected risk factor;
updating the personalized risk model after administering treatment, the updating including determining an updated risk level;
determining whether the updated risk level is above a threshold level; and
repeating the selecting, administering, updating and determining steps if the risk level is above the threshold level.

2. The method of claim 1, wherein selecting one of the risk factors comprises selecting a most influencing one of the risk factors.

3. The method of claim 1, wherein creating the personalized risk model comprises:
selecting a validated risk model;
applying the validated risk model to the patient data to determine the plurality of risk factors;
determining the overall risk level based on the validated risk model and the plurality of risk factors;
assessing a significance of each of the risk factors; and
assessing an expected likelihood of intervention of each of the risk factors,
wherein the personalized risk model includes the plurality of risk factors, the overall risk level, the significance of each of the risk factors, and the expected likelihood of intervention of each of the risk factors.

4. The method of claim 3, wherein the validated risk model is one of a Krumholz risk model and a Philbin risk model.

5. The method of claim 3, wherein the expected likelihood of success of each of the risk factors is determined based on results of a questionnaire relating to each of the risk factors given to the patient.

6. The method of claim 3, wherein the significance of each of the risk factors is based on the validated risk model.

7. The method of claim 3, wherein creating the personalized risk model further comprises:
classifying each of the risk factors as one of a medical risk factor, an unmodifiable psychosocial risk factor, and a modifiable psychosocial risk factor;
removing each of the risk factors that has been classified as a medical risk factor from the plurality of risk factors;
determining one or more modifiable psychosocial risk factors relating to each of the unmodifiable psychosocial risk factors; and
replacing each of the unmodifiable psychosocial risk factors with the one or more related modifiable psychosocial risk factors.

8. The method of claim 1, wherein the treatment relates to a patient maintenance behavior relating to the selected risk factor.

9. A system, comprising:
a memory storing a plurality of validated risk models; and
a processor receiving patient data for a patient, creating a personalized risk model for the patient based on the patient data, the personalized risk model including an overall risk level based on a plurality of risk factors, selecting one of the risk factors for treatment; receiving a result of treatment relating to the selected risk factor, updating the personalized risk model based on the result of treatment, the updating including determining an updated risk level, determining whether the updated risk level is above a threshold level, and selecting a further one of the risk factors for treatment if the risk level is above the threshold level.

10. The system of claim 9, the selected one of the risk factors is a most influencing one of the risk factors.

11. The system of claim 9, wherein, when creating the personalized risk model, the processor selects one of the validated risk models, applies the selected validated risk model to the patient data to determine the plurality of risk factors, determines the overall risk level based on the selected validated risk model and the plurality of risk factors, assesses a significance of each of the risk factors, and assesses an expected likelihood of intervention of each of the risk factors, wherein the personalized risk model includes the plurality of risk factors, the overall risk level, the significance of each of the risk factors, and the expected likelihood of intervention of each of the risk factors.

12. The system of claim 11, wherein the selected validated risk model is one of a Krumholz risk model and a Philbin risk model.

13. (canceled)

14. The system of claim 11, wherein the significance of each of the risk factors is based on the selected validated risk model.

15. The system of claim 11, wherein, when creating the validated risk model, the processor further classifies each of the risk factors as one of a medical risk factor, an unmodifiable psychosocial risk factor, and a modifiable psychosocial risk factor, removes each of the risk factors that has been classified as a medical risk factor from the plurality of risk factors, determines one or more modifiable psychosocial risk factors relating to each of the unmodifiable psychosocial risk factors, and replaces each of the unmodifiable psychosocial risk factors with the one or more related modifiable psychosocial risk factors.

16. (canceled)

17. A non-transitory computer-readable storage medium storing a set of instructions executable by a processor, the set of instructions being operable to:
receive patient data relating to a patient;
create a personalized risk model for the patient based on the patient data, the personalized risk model including an overall risk level based on a plurality of risk factors;
select one of the risk factors for a treatment;
receive a result of the treatment;
update the personalized risk model based on the result of the treatment, the updating including determining an updated risk level;
determine whether the updated risk level is above a threshold level; and
repeat the selecting, receiving, updating and determining steps if the risk level is above the threshold level.

18. (canceled)

19. (canceled)

20. (canceled)
